(19) United States
(12) Patent Application Publication
(10) Pub. No.: US 2026/0109346 A1
(43) Pub. Date: Apr. 23, 2026

(54) CONTROL DEVICE FOR MOBILE BODY

(71) Applicant: TOYOTA JIDOSHA KABUSHIKI KAISHA, Toyota-shi (JP)

(72) Inventors: Koutarou AOYAGI, Mishima-shi (JP); Yusuke HAYASHI, Atsugi-shi (JP); Taichi KAWANAI, Shizuoka-shi (JP)

(73) Assignee: TOYOTA JIDOSHA KABUSHIKI KAISHA, Toyota-shi (JP)

(21) Appl. No.: 19/309,329

(22) Filed: Aug. 25, 2025

(30) Foreign Application Priority Data
Oct. 22, 2024 (JP) 2024-185780

(51) Int. Cl. B60W 30/09; B60Q 5/00; B60W 30/095; B60W 30/14; B60W 50/14

(52) U.S. Cl. CPC B60W 30/09; B60Q 5/006; B60W 30/0956; B60W 30/146; B60W 50/14; B60W 2050/143; B60W 2050/146

(57) ABSTRACT

When an object that poses a collision risk with a mobile body is recognized, risk avoidance control is executed to avoid a collision with the object, and alarm control related to the risk avoidance control is executed for an occupant of the mobile body. The risk avoidance control includes first avoidance control and second avoidance control. The first avoidance control is executed before the collision risk reaches a prescribed level. The second avoidance control is executed after the collision risk reaches the prescribed level. Mobile vehicle control in the first avoidance control includes mobile body control with a smaller degree of collision avoidance with the object that poses the collision risk with the mobile body than the mobile body control in the second avoidance control.

The present application claims priority under 35 U.S.C. § 119 to Japanese Patent Application No. 2024-185780, filed on Oct. 22, 2024, the contents of which application are incorporated herein by reference in their entirety.

### TECHNICAL FIELD

The present disclosure relates to a device that controls a mobile body such as a vehicle.

### BACKGROUND

JP2022177522A discloses an alarm device mounted on a vehicle. This device of the related art identifies a traffic situation surrounding the vehicle based on information representing surroundings of the vehicle and information representing driving state of the vehicle. The device of the related art also predicts danger to the vehicle based on the identified traffic situation, and executes alarm control that is recognized by an occupant of the vehicle through one of the auditory, visual, and tactile senses. The manner of the alarm is switched depending on the predicted level of the danger. The device of the related art also executes danger avoidance control according to the predicted level of the danger. The danger avoidance control is vehicle control including at least one of deceleration and steering.

Consider a case in which the alarm control and the danger avoidance control are combined according to the predicted level of the danger. In this case, by performing the alarm control, information regarding the execution or expected execution of the danger avoidance control can be provided to the occupant. On the other hand, excessive execution of the danger avoidance control can reduce the driving efficiency of the vehicle. Moreover, excessive notification of the expected execution of the danger avoidance control may cause anxiety to the occupant. Therefore, it can be said that the device of the related art has room for improvement in terms of achieving both suppression of deterioration in the driving efficiency and appropriate notification to the occupant.

One objective of the present disclosure is to provide a technology that can simultaneously suppress deterioration in the driving efficiency of a mobile body due to excessive execution of danger avoidance control and provide an appropriate notification to an occupant of the mobile body regarding notification of the danger avoidance control.

### SUMMARY

The present disclosure is a control device for mobile body having the following features. The control device comprises one or more memory devices in which driving environment information of a mobile body is stored, and one or more processors configured to execute various types of controls based on the driving environment information. The various types of controls include risk avoidance control and alarm control related to the risk avoidance control. The risk avoidance control is executed to avoid a collision with an object when the object that poses a collision risk with the mobile body is recognized. The alarm control is executed for an occupant of the mobile body. The risk avoidance control includes first avoidance control and second avoidance control. The first avoidance control is executed before the collision risk reaches a prescribed level. The second avoidance control is executed after the collision risk reaches the prescribed level. Mobile vehicle control in the first avoidance control includes mobile body control with a smaller degree of collision avoidance with the object that poses the collision risk with the mobile body than the mobile body control in the second avoidance control. The alarm control includes warning that the second avoidance control is expected to be executed.

According to the present disclosure, before the collision risk reaches the prescribed level, the first avoidance control is executed that has a smaller degree of collision avoidance than the second avoidance control that is executed after the collision risk reaches the prescribed level. By executing the first avoidance control with a smaller degree of collision avoidance, it is possible to prevent a decrease in driving efficiency caused by excessive execution of the risk avoidance control. According to the present disclosure, since the possibility of the execution of the second avoidance control is warned in the alarm control, it is also possible to give an appropriate notification to an occupant of the mobile body regarding the execution of the second avoidance control. Therefore, it is possible to simultaneously suppress a decrease in the driving efficiency due to excessive execution of the risk avoidance control and appropriately notify the occupant of the execution of the risk avoidance control.

### BRIEF DESCRIPTION OF THE DRAWINGS

FIG. 1 is a diagram explaining risk avoidance control;

FIG. 2 is a diagram explaining features of an embodiment of the present disclosure;

FIG. 3 is a block diagram showing an example of an overall configuration of a mobile body system including a control device according to the embodiment;

FIG. 4 is a timing chart showing an example of the risk avoidance control and alarm control;

FIG. 5 is a timing chart showing an example of the risk avoidance control and the alarm control; and

FIG. 6 is a timing chart showing an example of the risk avoidance control and the alarm control.

### DESCRIPTION OF EMBODIMENT

A control device for mobile body according to an embodiment of the present disclosure will now be described with reference to the drawings.

### 1. Risk Avoidance Control

The control device according to the embodiment executes travel assistance control that assists a driving of a mobile body such as a taxi and a bus. This travel assistance control may be included in autonomous driving control. Typically, the control device according to the embodiment is mounted on a mobile body MB. Some functions of the control device according to the embodiment may be located in a device outside the mobile body MB (e.g., an external server), and in this case, the travel assistance control may be performed remotely. In other words, the functions of the control device according to the embodiment may be distributed between the mobile body MB and the external device.

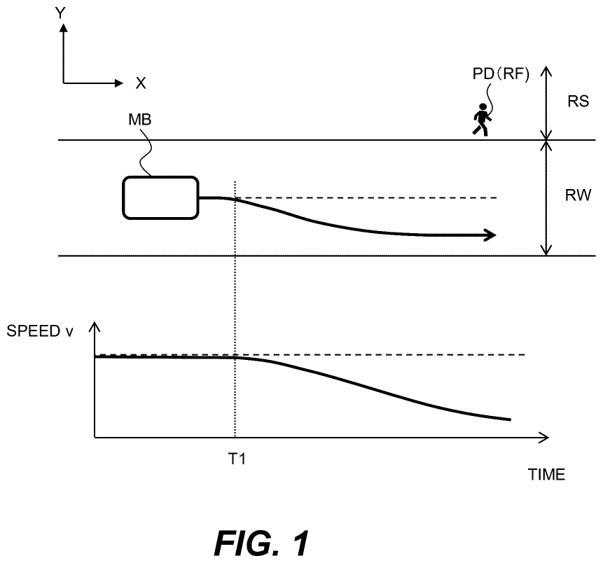

The travel assistance control includes “risk avoidance control” for avoiding a risk factor RF in front of the mobile body MB. FIG. 1 is a diagram explaining risk avoidance control. Here, the X direction shown in FIG. 1 is a travel direction of the mobile body MB, and the Y direction is a planar direction perpendicular to the X direction. However, the coordinate system (X, Y) is not limited to this example.

In the risk avoidance control, at least one of steering and deceleration of the mobile body MB is controlled in order to avoid the risk factor RF recognized in front of the mobile body MB. For example, in FIG. 1, the mobile body MB is traveling on a roadway RW. A breakdown lane RS is adjacent to the roadway RW. A walker PD in the breakdown lane RS ahead of the mobile body MB may enter the roadway RW. Therefore, the walker PD can be said to be the risk factor RF.

In the example shown in FIG. 1, the risk avoidance control includes both steering control and deceleration control. In the steering control, the steering device of the mobile body MB is controlled in a direction away from the walker PD. In the deceleration control, a braking device of the mobile body MB is controlled such that speed v decreases as the mobile body MB approaches the walker PD. In the example shown in FIG. 1, steering control and deceleration control are initiated at time t1. However, the steering control and deceleration control do not have to start at the same time. The walker PD may also be another mobile body (e.g., a motorcycle or a vehicle). In addition to the breakdown lane RS, a walker on the roadway RW is also included in the risk factor RF.

### 2. Feature of Risk Avoidance Control According to Embodiment

As already explained, the risk avoidance control is carried out to avoid the risk factor RF. Therefore, when the risk avoidance control is performed, a risk to collide (a collision risk) of the mobile body MB with the risk factor RF is calculated. The collision risk is calculated based on, for example, a time-to-collision (TTC) of the mobile body MB relative to the risk factor RF. The time TTC is calculated based on, for example, the position and speed information of the risk factor RF and the position and speed information of the mobile body MB. Once the collision risk has been calculated, the collision risk is converted into a risk level RLv (e.g., RLv=constant k*1/TTC), and if the risk level RLv rises above a prescribed level Lvth, the risk avoidance control is initiated.

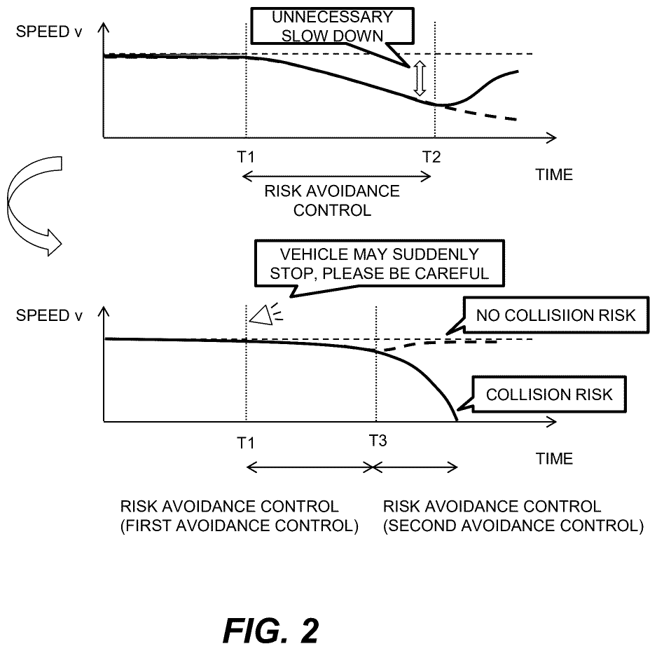

In the risk avoidance control, at least one of the steering device and the braking device of the mobile body MB is controlled to avoid a collision (or a contact) with the risk factor RF. FIG. 2 is a diagram explaining features of the embodiment. In explaining FIG. 2, we will focus on the deceleration control, which is part of the risk avoidance control. In the top part of FIG. 2, the deceleration control is executed from time t1 to time t2. If the collision (or the contact) with the risk factor RF is to be avoided, it is desirable to sufficiently reduce the speed v of the mobile body MB.

However, the calculation of the collision risk (the risk level RLv) is still performed during the risk avoidance control. Therefore, if the risk level RLv falls below the prescribed level Lvth during the risk avoidance control, the execution of the risk avoidance control will be terminated and control will return to normal control. However, if the speed v of the mobile body MB is sufficiently reduced by the risk avoidance control, it will take time for the speed v to return to the speed v before risk avoidance control was executed, which will reduce the driving efficiency of the mobile body MB.

Therefore, in the risk avoidance control according to the embodiment, a two-stage risk avoidance control is set up and executed. Specifically, when the risk level RLv rises to or above a first prescribed level Lvth1 (=Lvth), a first risk avoidance control (hereinafter also referred to as “first avoidance control”) with a relatively low collision avoidance is executed. Then, if the risk level RLv rises above a second prescribed level Lvth2 (>Lvth1) during the first risk avoidance control, a second risk avoidance control (hereinafter also referred to as “second avoidance control”) with a relatively high collision avoidance is executed.

The degree of the collision avoidance can be adjusted by varying target deceleration a. For example, in the first avoidance control, the target deceleration a is set to deceleration a0 (e.g., 0.05 G), and in the second avoidance control, the target deceleration a is set to deceleration a1 (e.g., maximum deceleration). This allows a slow deceleration with a low collision avoidance to be executed in the first avoidance control, and a rapid deceleration with a high collision avoidance to be executed in the second avoidance control.

The degree of the collision avoidance can also be varied by setting different target steering angles θ. For example, the target steering angle θ is set to ±θ0 in the first avoidance control whereas the target steering angle θ is set to ±θ1 (>θ0) in the second avoidance control. This allows gentle steering with the low collision avoidance to be executed in the first avoidance control, and a sudden steering with the high collision avoidance to be executed in the second avoidance control.

The bottom part of FIG. 2 shows an example of the risk avoidance control according to the embodiment. In the example shown in the bottom part, the first avoidance control is carried out from time t1 to time t3. Also, from time t3 onwards, the execution of the first avoidance control is switched to the execution of the second avoidance control. The reason for this is that the risk level RLv rose to or above the second prescribed level Lvth2 during the first avoidance control (solid line: the collision risk). If the risk level RLv falls below the first prescribed level Lvth1, the second avoidance control is not executed, the execution of the first avoidance control is stopped, and the control returns to normal control (dotted line: no collision risk).

By setting such a two-stage risk avoidance control, if the risk level RLv falls below the first prescribed level Lvth1 during the first avoidance control, the time required to return to the speed v before the first avoidance control was executed can be shortened, thereby suppressing a decrease in the driving efficiency of the mobile body MB. On the other hand, if the risk level RLv rises to or exceeds the second prescribed level Lvth2 during the first avoidance control, the execution of the second avoidance control is switched to, making it possible to avoid a collision (or a contact) with the risk factor RF.

However, when the risk avoidance control is executed in the two-stage, an attitude of the mobile body MB changes suddenly when the second avoidance control is initiated, which may compromise the safety of an occupant of the mobile body MB. Therefore, in the embodiment, during the execution of the first avoidance control, alarm control is executed regarding the possibility of executing the second avoidance control. As shown in the bottom part of FIG. 2, in the alarm control, announcement sounds such as “the vehicle may suddenly stop (sway sideways), please be careful” or “the vehicle may suddenly stop (sway sideways), please hold on to the handrail if you are standing” are played from an indoor speaker. In the alarm control, an announcement display described above may be output from an in-room display.

When the first avoidance control begins, the alarm control regarding the execution of the first avoidance control can also be executed. However, in the embodiment in which the risk avoidance control may be executed in the two-stage, excessive notification of the execution of the risk avoidance control or a notice of its execution may cause anxiety to the occupant. Therefore, in the alarm control according to the embodiment, no information is provided regarding the execution of the first avoidance control, but only information is provided regarding the possibility of executing the second avoidance control, which has the high collision avoidance. This allows information regarding the execution of the risk avoidance control to be delivered to the occupant in an appropriate manner.

### 3. System Configuration Example

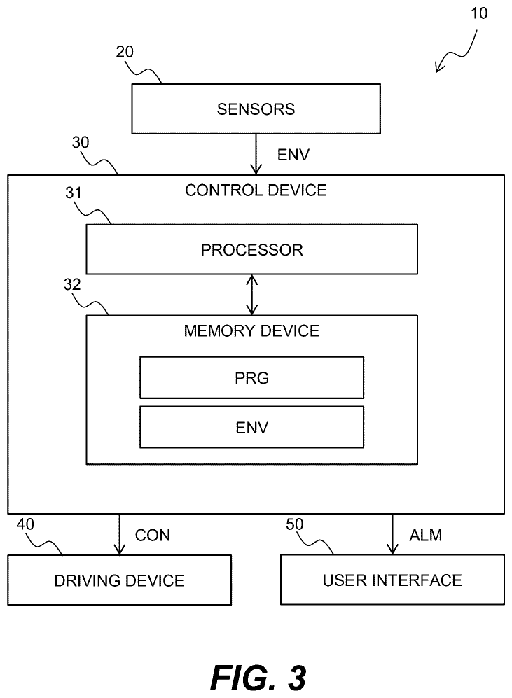

FIG. 3 is a block diagram showing an example of an overall configuration of a mobile body system 10 including the control device associated with the embodiment. The mobile body system 10 shown in FIG. 3 is mounted on the mobile body MB. The mobile body system 10 includes sensors 20, a control device 30, a driving device 40, and a user interface 50.

The sensors 20 include, for example, a status sensor, a recognition sensor, a position sensor, and the like. The state sensor detects the state of the mobile body MB. For example, the state sensors detect the speed, lateral acceleration, yaw rate, steering angle, etc. of the mobile body MB. The recognition sensor recognizes (detects) the surrounding situation of the mobile body MB. Examples of the recognition sensor include a camera, a LIDAR (Laser Imaging Detection and Ranging), and a radar. The position sensor detects the position and orientation of the mobile body MB. The position sensor includes a Global Navigation Satellite System (GNSS).

The control device 30 is a component that corresponds to a control device according to the embodiment. The control device 30 includes one or more processors 31 (hereinafter also simply referred to as a “processor 31”) and one or more memory devices 32 (hereinafter also simply referred to as a “memory device 32”). The processor 31 executes various types of processing. Examples of the processor 31 include a CPU (Central Processing Unit), a GPU (Graphics Processing Unit), ASICs (Application Specific Integrated Circuits), and an FPGA (Field-Programmable Gate Array). The memory device 32 stores various types of information. Examples of the memory device 32 include a volatile memory, a non-volatile memory, a hard disk drive (HDD), and a solid state drive (SSD). The control device 30 may include one or more control devices.

The memory device 32 stores various information necessary for processing by the processor 31. The various information includes a control program PRG. The control program PRG is a computer program for controlling the mobile body MB, and is executed by the processor 31. The control program PRG may be recorded on a computer-readable recording medium. The processor 31 executes the control program PRG to realize various functions of the control device 30.

The various information also includes driving environment information ENV. Examples of the driving environment information ENV include state information, surrounding situation information, and positional information. The state information is information that indicates the state of the mobile body MB. The surrounding situation information is information that indicates the situation around the mobile body MB. The positional information is information that indicates the position and direction of the mobile body MB. The driving environment information ENV is acquired by the sensors 20 and stored in the memory device 32.

The driving device 40 includes a steering device, a driving device, and a braking device. The steering device steers the mobile body MB. For example, the steering device includes electric power steering (EPS) device. The driving device is a power source that generates driving force. Examples of the driving device include an engine, an electric motor, and an in-wheel motor. The braking device generates braking force. The driving device 40 is controlled based on instructions for control CON from the control device 30. The instruction for control CON includes instructions for implementing risk avoidance control.

The user interface 50 presents information to a user of the mobile body MB. The users of the mobile body MB include a driver and a passenger aboard the mobile body MB. The user interface 50 includes an input device, a display device, and a speaker. Examples of the input device include a touch panel and a switch. Examples of the display device include a meter panel, a display, and a head-up display (HUD). The user interface 50 is controlled based on an alarm instruction ALM from the control device 30. The alarm instruction ALM contains the instruction for executing the alarm control.

### 4. Example of Combination of Risk Avoidance Control and Alarm Control

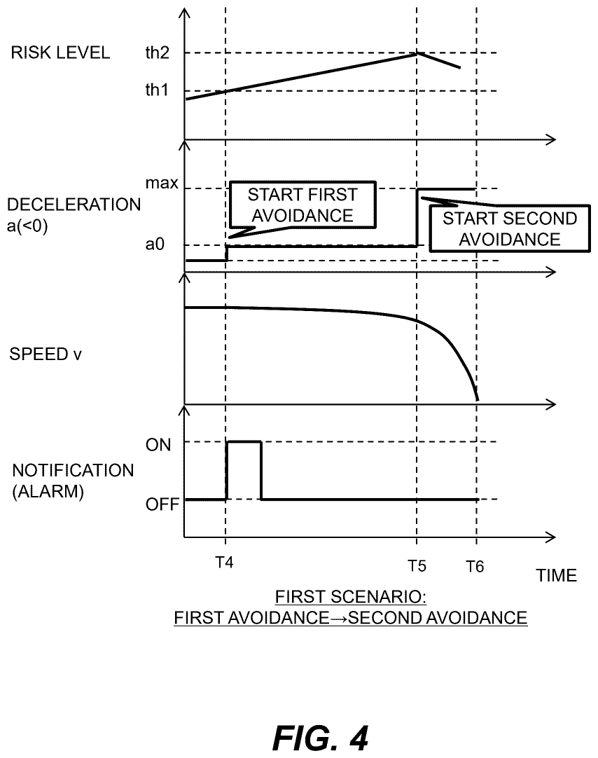

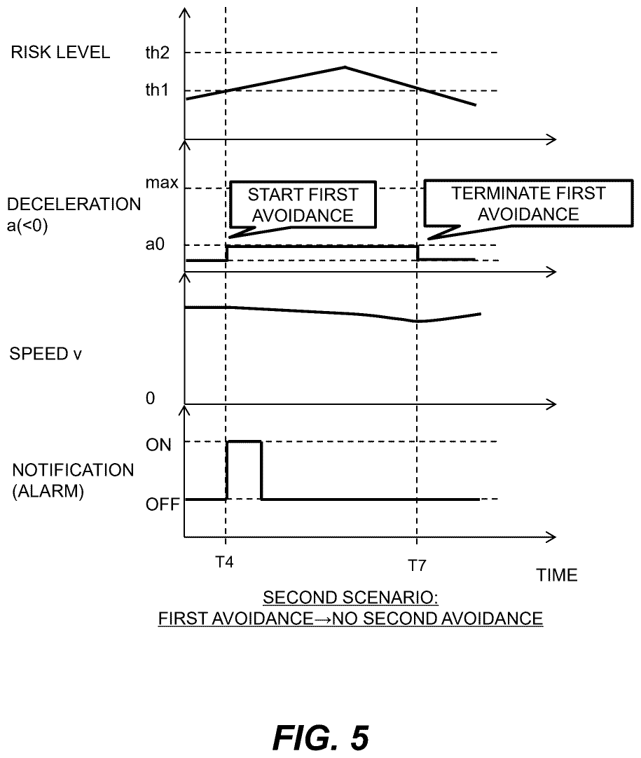

FIGS. 4 and 5 are timing charts showing examples of risk avoidance control and alarm control. Two scenarios are depicted in FIGS. 4 and 5. In the scenario shown in FIG. 4, the first and second avoidance controls are executed. In the scenario shown in FIG. 5, only the first avoidance control is executed.

In the example shown in FIGS. 4 and 5, the first avoidance control begins at time t4 when the risk level RLv reaches the first prescribed level Lvth1. In the first avoidance control, the target deceleration a of the deceleration control is set to deceleration a0, and the driving device (the braking device) of the mobile body MB is controlled. In the example shown in FIGS. 4 and 5, the alarm control is also temporarily executed at time t4.

In the example shown in FIG. 4, the risk level RLv continues to rise after time t4. Then, from time t5 when the risk level RLv reaches the second prescribed level Lvth2, the execution of the second avoidance control is started. In the second avoidance control, the target deceleration a of the deceleration control is set to the maximum deceleration amax, and the driving device (the braking device) of the mobile body MB is controlled. The second avoidance control ends at time t6 when the mobile body MB stops. On the other hand, in the example shown in FIG. 5, the risk level RLv starts to decrease after time t4. Then, at time t7 when the risk level RLv falls below the first prescribed level Lvth1, the execution of the first avoidance control ends, and normal control is started.

In this way, depending on the transition of the risk level RLv during the first avoidance control, a switch from the first avoidance control to the second avoidance control is made, or the first avoidance control ends without this switch. In addition, when the first avoidance control begins to be executed, the execution of the second avoidance control in the future is announced.

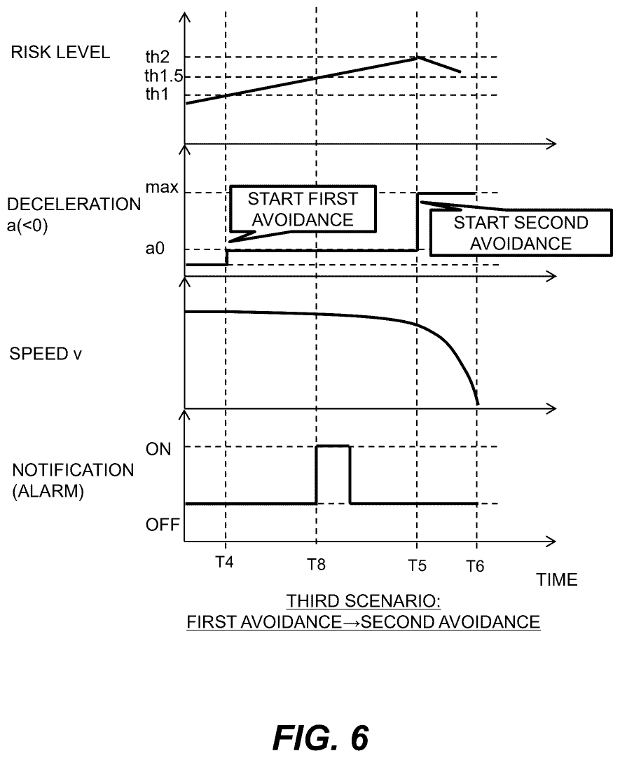

FIG. 6 is a timing chart showing another example of the execution of the risk avoidance control and alarm control. The scenario depicted in FIG. 6 is essentially the same as the one shown in FIG. 4. The difference between the two is the start time of the alarm control. That is, in the scenario shown in FIG. 6, the alarm control is temporarily performed at time t8 when the risk level RLv reaches the prescribed level Lvth1.5, which is intermediate between the first prescribed level Lvth1 and the second prescribed level Lvth2. In this way, the execution timing of the alarm control can be set to any timing during the first avoidance control, and such execution timing can be set according to the risk level RLv.

### 5. Combination with Warning Control

In the embodiment, in addition to the risk avoidance control and alarm control described above, warning control may be executed. In the warning control, for example, a horn of the mobile body MB is controlled and a warning sound is emitted toward the risk factor RF. The timing of the execution of the warning control is, for example, simultaneously with the start of the execution of the alarm control or before the start of the execution of the alarm control. By performing the warning control simultaneously with or before the start of the alarm control execution, it is possible to encourage the risk factor RF to adopt a behavior that avoids the collision (or the contact) with the risk factor RF. Incidentally, the timing of executing the warning control can be set according to the risk level RLv, similar to the setting of the timing of executing the alarm control.

What is claimed is:

1. A control device for mobile body; comprising:
one or more memory devices in which driving environment information of a mobile body is stored; and
one or more processors configured to execute various types of controls based on the driving environment information,
wherein the various types of controls include risk avoidance control and alarm control related to the risk avoidance control, wherein the risk avoidance control is executed to avoid a collision with an object when the object that poses a collision risk with the mobile body is recognized, wherein the alarm control is executed for an occupant of the mobile body,
wherein the risk avoidance control includes first avoidance control and second avoidance control, wherein the first avoidance control is executed before the collision risk reaches a prescribed level, wherein the second avoidance control is executed after the collision risk reaches the prescribed level,
wherein mobile vehicle control in the first avoidance control includes mobile body control with a smaller degree of collision avoidance with the object that poses the collision risk with the mobile body than the mobile body control in the second avoidance control,
wherein the alarm control includes warning that the second avoidance control is expected to be executed.

2. The control device according to claim 1,
wherein the alarm control is executed during the execution of the first avoidance control.

3. The control device according to claim 1,
wherein the alarm control does not include a provision of information regarding the execution of the first avoidance control.

4. The control device according to claim 1,
wherein the second avoidance control includes deceleration control at a maximum deceleration of the mobile body.

5. The control device according to claim 1,
wherein the various types of controls include warning control to emit a warning sound toward an object when the object that poses a collision risk with the mobile body is recognized,
wherein the warning control is executed simultaneously with or before the start of the execution of the alarm control.
